(19) United States
(12) Patent Application Publication
(10) Pub. No.: US 2025/0302693 A1
(43) Pub. Date: Oct. 2, 2025

(54) CPR FEEDBACK PUCK COMPATIBLE WITH A CHEST COMPRESSION SYSTEM AND MEANS OF COUPLING

(71) Applicant: PHYSIO-CONTROL, INC., Redmond, WA (US)

(72) Inventors: Adam Harvey, Lisburn (GB); Steven Chester, Kirkland, WA (US); Fred W. Chapman, Newcastle, WA (US)

(73) Assignee: PHYSIO-CONTROL, INC., Redmond, WA (US)

(21) Appl. No.: 19/092,724

(22) Filed: Mar. 27, 2025

Related U.S. Application Data
(60) Provisional application No. 63/571,376, filed on Mar. 28, 2024.

(51) Int. Cl. A61H 31/00

(52) U.S. Cl. CPC A61H 31/005

(57) ABSTRACT

In embodiments, a mechanical cardiopulmonary resuscitation (CPR) device includes a piston configured to extend toward and away from a patient's chest. The CPR device has a suction cup secured to an end of the piston, and the CPR device includes a removable CPR puck having a surface structured to be secured to the suction cup.

### PRIORITY

This disclosure claims the benefit of U.S. Provisional Application No. 63/571,376, filed on Mar. 28, 2024, which is incorporated herein by reference in its entirety.

### TECHNICAL FIELD

The subject matter is related to an apparatus and methods for providing feedback to manual CPR, and, more particularly, to a system and methods for coupling a manual CPR feedback device with a mechanical CPR device to prevent interference of the feedback device with treatment from the mechanical CPR device.

### BACKGROUND

In certain types of medical emergencies a patient's heart stops working, which stops the blood from flowing. Without the blood flowing, organs like the brain will start becoming damaged, and the patient will soon die. Cardiopulmonary resuscitation (CPR) can forestall these risks. CPR includes performing repeated chest compressions to the chest of the patient, so as to cause the patient's blood to circulate some. CPR also includes delivering rescue breaths to the patient, so as to create air circulation in the lungs. CPR is intended to merely forestall organ damage and death, until a more definitive treatment is made available. Defibrillation is one such a definitive treatment: it is an electric shock delivered deliberately to the patient's heart, in the hope of restoring the heart rhythm.

Guidelines by medical experts such as the American Heart Association provide parameters for CPR to cause the blood to circulate effectively. The parameters are for aspects such as the frequency of the chest compressions, the depth that they should reach, and the full release that is to follow each of them. If the patient is an adult, the depth is sometimes required to reach 5 cm (2 in.). The parameters for CPR may also include instructions for the rescue breaths.

Traditionally, CPR has been performed manually. A number of people have been trained in CPR, including some who are not in the medical professions, just in case they are bystanders in a medical emergency event.

Manual CPR may be ineffective, however. Indeed, the rescuer might not be able to recall their training, especially under the stress of the moment. And even the best trained rescuer can become fatigued from performing the chest compressions for a long time, at which point their performance may become degraded. In the end, chest compressions that are not frequent enough, not deep enough, or not followed by a full release may fail to maintain the blood circulation required to forestall organ damage and death.

The risk of ineffective chest compressions has been addressed with CPR chest compression machines. Such machines have been known by a number of names, for example CPR chest compression machines, CPR machines, mechanical CPR devices, cardiac compressors, CPR devices, CPR systems, and so on.

The repeated chest compressions of CPR are actually compressions alternating with releases. The compressions cause the chest to be compressed from its original shape. During the releases the chest is decompressing, which means that the chest is undergoing the process of returning to its original shape. This decompressing does not happen immediately upon a quick release. In fact, full decompression might not be attained by the time the next compression is performed. In addition, the chest may start collapsing due to the repeated compressions, which means that it might not fully return to its original height, even if it were given ample opportunity to do so.

Some CPR chest compression machines compress the chest by a piston. Some may even have a suction cup at the end of the piston, with which these machines lift the chest at least during the releases. This lifting may actively assist the chest, in decompressing the chest faster than the chest would accomplish by itself. This type of lifting is sometimes called active decompression.

Devices exist for providing CPR feedback to rescuers, particularly to rescuers performing manual CPR. For example, disposable defibrillation electrodes are available that can provide feedback to a rescuer about the depth and rate of compressions. These devices often include a puck placed at the compression point on a patient's chest, which may interfere with treatment when a CPR device is applied. For instance, when used in tandem with CPR devices having a suction cup for performing active decompressions, the puck may prevent the suction cup from properly adhering to the patient's chest. Additionally, the puck may cause the piston to deviate from an optimal compression point on the patient's chest. During a rescue event, these obstacles to effective treatment may not be apparent to the rescuer.

Configurations of the disclosed technology address shortcomings in the prior art.

### BRIEF DESCRIPTION OF THE DRAWINGS

FIG. 1 is a perspective view of a CPR device with a compatible feedback puck, according to an example configuration.

FIG. 2 is a front view of the CPR device of FIG. 1, also showing a representation of a patient within the CPR device.

FIG. 3 is a perspective view of a feedback puck assembly compatible with a CPR device, according to an example configuration.

FIG. 4 is cross-sectional view of the feedback puck assembly of FIG. 3, sectioned as identified in FIG. 2.

FIG. 5 is a perspective view of a feedback puck assembly implemented with a CPR device, according to an additional example configuration.

FIG. 6 is a perspective view of the feedback puck assembly of FIG. 5 in a locked position.

FIG. 7 is a perspective view of the feedback puck assembly of FIG. 5 in an unlocked position.

FIG. 8 is a cross-sectional view of the feedback puck assembly of FIG. 5, sectioned as identified in FIG. 6.

FIG. 9 is a perspective view of a feedback puck assembly implemented with a CPR device, according to an additional example configuration.

FIG. 10 is a perspective view of the feedback puck assembly of FIG. 9.

FIG. 11 is a cross-sectional view of the feedback puck assembly of FIG. 9, sectioned as identified in FIG. 10.

FIG. 12 is a perspective view of a feedback puck assembly compatible with a CPR device, according to an additional example configuration.

FIG. 13 is an exploded view of the feedback puck assembly of FIG. 12.

### DETAILED DESCRIPTION

As described herein, aspects are directed to a CPR feedback puck for use during manual CPR that may couple with a mechanical CPR device. Configurations of the disclosed technology provide a means of coupling an existing CPR feedback puck with a mechanical CPR device. Additionally or alternatively, configurations of the disclosure provide a CPR feedback puck designed as a component of a CPR device. In configurations, a CPR feedback puck is structured to be adhered to and remained positioned on a patient's chest such that the CPR device may effectively attach to the patient's chest over the puck. In still other configurations, a CPR feedback puck is structured to be used during manual compressions and then coupled with the piston of a CPR device.

Furthermore, aspects of the disclosure are directed to determining whether a foreign object, such as a CPR feedback puck for manual CPR, is being used in conjunction with a mechanical CPR device. In configurations, the disclosed CPR system may provide audio and/or visual prompts to a rescuer to remove one of the devices or take measures to ensure that compressions performed by the CPR device are optimal.

As mentioned, typical CPR feedback pucks provide feedback to a rescuer performing manual compressions. Such feedback pucks measure parameters like depth and rate of compressions to provide real time feedback regarding the quality of compressions being performed, and they are often adhered to a patient's chest at a point where compressions are to be applied. In situations where a rescuer performs manual compressions but later switches to treatment performed by a CPR device, these feedback pucks may hinder the effectiveness of treatment. Accordingly, aspects of the disclosed technology are directed to a feedback puck that may couple with a CPR device without interfering with the treatment performed by the CPR device.

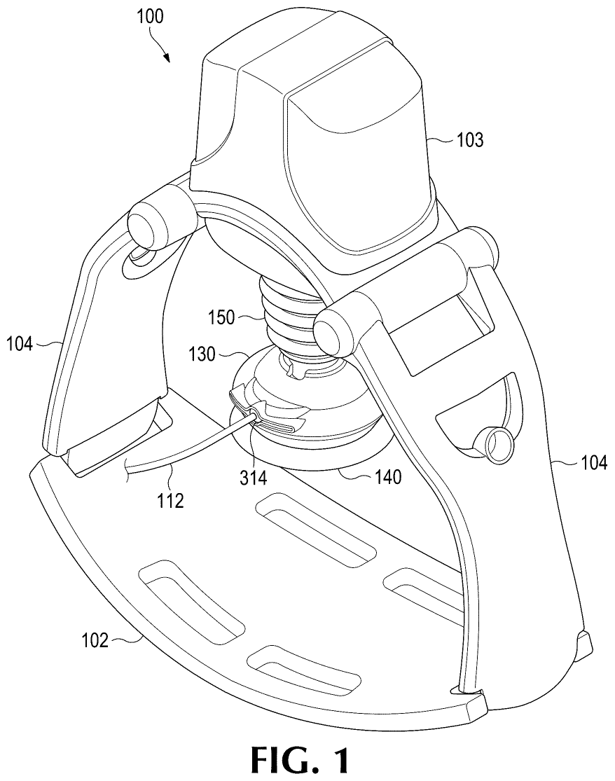

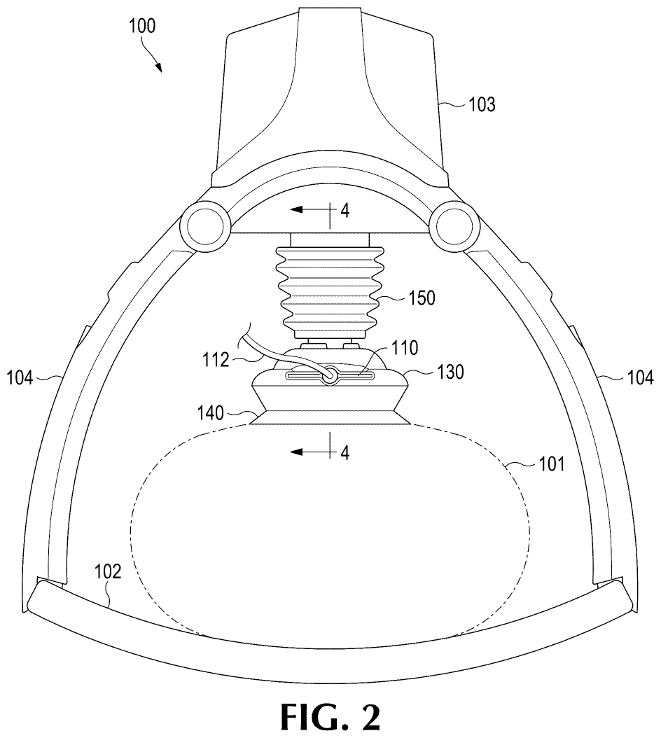

FIG. 1 is a perspective view showing portions of a CPR device 100, according to embodiments. FIG. 2 is a front view of the CPR device 100 of FIG. 1, also showing a representation of a patient 101 within the CPR device 100. As illustrated in FIGS. 1 and 2, a CPR device 100 may include a base member 102, a chest compression mechanism 103, and a support leg 104.

The chest compression mechanism 103 may be configured to deliver CPR chest compressions to the patient 101. The chest compression mechanism 103 may include, for example, a suction cup 140 and a motor-driven piston 150. The motor-driven piston 150 may be configured to contact the patient's chest to provide the CPR chest compressions, and the suction cup 140 may be configured to attach to the patient's chest to provide lifting force to the chest, also referred to as active decompressions.

The support leg 104 may be configured to support the chest compression mechanism 103 at a distance from the base member 102. For example, if the base member 102 is underneath the patient 101, who is lying on the patient's back, then the support leg 104 may support the chest compression mechanism 103 at a sufficient distance over the base member 102 to allow the patient 101 to lay within a space between the base member 102 and the chest compression mechanism 103, while positioning the chest compression mechanism 103 over the patient's chest.

In embodiments, there may be two support legs 104. In embodiments, the two support legs 104 may together form an arch to support the chest compression mechanism 103. An example of such a configuration is illustrated in FIGS. 1-2.

FIGS. 1-2 also illustrate a feedback puck 110 implemented with the CPR device 100. As shown, the feedback puck 110 may sit above the suction cup 140. In configurations, described further throughout the disclosure, the feedback puck 110 may be a removable accessory for the CPR device or may be implemented entirely separate from the CPR device. For the purposes of this disclosure, “removable” means that the components can be separated and moved away from each other without causing permanent damage to either component. For instance, feedback puck 110 may be in a removable case 130. In still other configurations, the feedback puck 110 may instead be integral to the CPR device 100—that is, the feedback puck 110 may be included as a component of the complete CPR device 100. In configurations, feedback puck 110 may be electrically connected to the CPR device with an electrical cable 112.

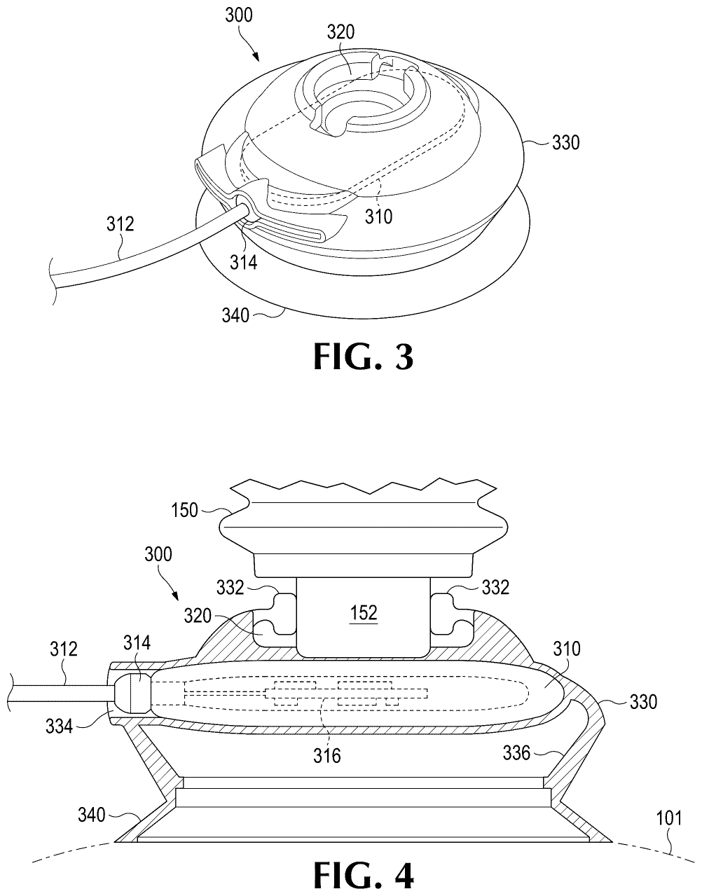

FIGS. 3-4 show details of an example puck assembly 300 for implementation with a CPR device, such as the one illustrated in FIGS. 1-2. As shown in FIG. 3, the puck assembly 300 has a feedback puck 310 and an electrical cable 312 for electrically connecting the feedback puck 310 to the CPR device. Additionally or alternatively, electrical cable 312 may electrically connect feedback puck 310 to a user interface of the CPR device with which puck assembly 300 is implemented, or electrical cable 312 may electrically connect feedback puck with a communication module for cooperation with other medical devices, such as a defibrillator. In this way, feedback puck 310 may measure parameters relating to the quality of CPR—such as depth and rate of compressions—and transmit signals to be outputted in a human-perceptible form. In additional or alternative configurations, electrical cable 312 electrically connects feedback puck 310 directly to an external device, such as a manual defibrillator or automated external defibrillator (AED). In such configurations, feedback puck 310 may be implemented with the external device before a mechanical CPR device is used. For example, feedback puck 310 can be implemented while a rescuer alternates between manual compressions and treatment with a defibrillator or other external device, then feedback puck 310 can subsequently be implemented with a mechanical CPR device, according to the disclosed configurations.

As shown in FIG. 3, feedback puck 310 is substantially contained within a case 330, which also substantially contains a suction cup 340. For the purposes of this disclosure “substantially contained” means largely or essentially kept within the limits of a component, without requiring perfecting positioning within the limits. In this way, when assembled and implemented with a CPR device such as the one shown in FIGS. 1-2, puck assembly 300 may be unitary-that is, the puck assembly 300 may move together as one unit and may thus be removed from or attached to the CPR device as one unit. Additionally, in configurations such as the example puck assembly 300 of FIG. 3, case 330 may be shaped to have a recess 320. In particular, recess 320 may be shaped to receive the piston of the CPR device, allowing CPR puck assembly 300 to be attached to the piston. Electrical cable 312, as shown, may extend laterally away from the case 330, such that the electrical cable 312 remains away from the travel path of the puck assembly 300 when implemented with a CPR device, such as the example of FIGS. 1-2.

FIG. 4 illustrates a cross sectional view showing further detail of the CPR puck assembly 300, according to the cross section identified in FIG. 2. As shown, the case 330 is structured to allow the puck assembly 300 to be attached to a terminal end 152 of the piston 150 of a CPR device. In particular, the case 330 has at least one gasket 332 extending from an upper portion of the case 330 such that it may contact the terminal end 152 of the piston 150 when it is received in recess 320. Gasket 332 may thus secure the terminal end 152 of the piston 150 within the recess 320 via friction and/or pressure seal.

Furthermore, as shown, the case 330 substantially contains both the puck 310 and the suction cup 340, such that both the puck 310 and the suction cup 340 may be secured to a terminal end 152 of the piston 150 as a single unit. To contain both the puck 310 and the suction cup 340, the case 330 is shaped to have sleeves 334, 336 for the puck 310 and the suction cup 340, respectively. Accordingly, in configurations, both the puck 310 and the suction cup 340 may be inserted into and removed from sleeves 334, 336. In still other configurations, the suction cup 340 may be permanently inserted in sleeve 336, while the puck 310 is removable from sleeve 334.

For instance, in configurations such as those just described with regard to FIG. 4, a rescuer may begin treatment of a patient with manual compressions. The rescuer may use the puck 310 to measure the quality of the manual compressions, for instance, by adhering the puck 310—removed from its sleeve 334 of the puck assembly 300-to the patient's chest at a location where compressions are to be performed. The rescuer may perform the compressions and, in turn, may receive feedback from the puck 310 as a CPR device is prepared for use on the patient, perhaps by another rescuer. The rescuer performing manual compressions may decide to stop performing the manual compressions and instead begin compression performed by the CPR device. Accordingly, the rescuer implementing a CPR device and puck assembly 300, in configurations, may remove the puck 310 from the patient's chest and insert the puck 310 into its corresponding sleeve 334 of the puck assembly 300. Once the puck 310 is inserted into the corresponding sleeve 334, the rescuer may then initiate the compressions performed by the CPR device.

Referring once again to FIG. 4, as compressions are performed by the CPR device to the chest of the patient 101, the puck assembly 300 may travel with the piston 150 due to the attachment of the puck assembly 300 to the terminal end 152 described above. In this way, the surface of the suction cup 340 facing the chest of the patient 101 contacts the chest as compressions, or active decompressions, are performed. The puck 310, conversely, remains between the suction cup 340 and the piston 150 and thus travels toward and away from the chest of the patient 101 without contacting the chest of the patient 101. Because the puck 310 remains above the suction cup 340 and does not contact the chest of the patient 101, the puck 310 does not interfere with the interfacing between the chest and the suction cup 340. Consequently, the position of the puck 310 within the puck assembly 300 prevents loosening of the connection between the chest and the suction cup 340 that may hinder compressions or active decompressions. Furthermore, the position of the puck 310 prevents drift of the piston away from a desired compression location on the chest of the patient 101.

FIG. 4 also shows further details of puck 310. As shown, puck 310 has a connector 314 at which electrical cable 312 may electrically connect the internal circuitry of puck 310, which may comprise sensors 316, to the CPR device or other external medical device. Connector 314, in configurations, may be an electrical port, allowing electrical cable 312 to be inserted into and removed from connector 314. Connector 314 may be a permanently wired connection, in configurations. Finally, although a wired connection is illustrated in FIG. 4, the connection between the internal sensors 316 and the CPR device or other external medical device may be wireless.

As discussed above with regard to FIG. 4, puck assembly 300 may attach to a terminal end 152 of piston 150 via a recess 320 and gasket 332—that is, via a geometric coupling. Accordingly, puck assembly 300 may be attached to and removed from piston 150 quickly and easily. Puck assembly 300 may be attached to piston 150, for example, by simply pushing puck assembly 300 over terminal end 152, with recess 320 facing the terminal end 152. Similarly, puck assembly 300 may be removed from piston 150 by pulling puck assembly away from piston 150.

In configurations, puck assembly 300 may instead be coupled with piston 150 via a magnet. For instance, a permanent magnet may be disposed at terminal end 152 of piston 152, and a magnetic material may be disposed on a surface of puck assembly 300 interfacing with terminal end 152. Alternatively, configurations of puck of assembly 300 may implement an electromagnet at the terminal end 152 of piston 150, such that the terminal end 152 may attract puck assembly 300 and allow for secure attachment when the CPR is powered.

Although a suction cup 340 is illustrated in FIGS. 3-4, puck assembly 300 may include a different component for interfacing with the patient's chest. For example, puck assembly 300 may instead use a compression pad configured to deliver compressions to the patient's chest, but not capable of being secured to the patient's chest to perform active decompression. In configurations implementing a compression pad, puck assembly 300 may therefore have a sleeve shaped differently from sleeve 336 to receive the compressions pad. Nonetheless, in configurations implementing a compressions pad, puck assembly 300 may still have a sleeve 334 shaped to receive the puck 310.

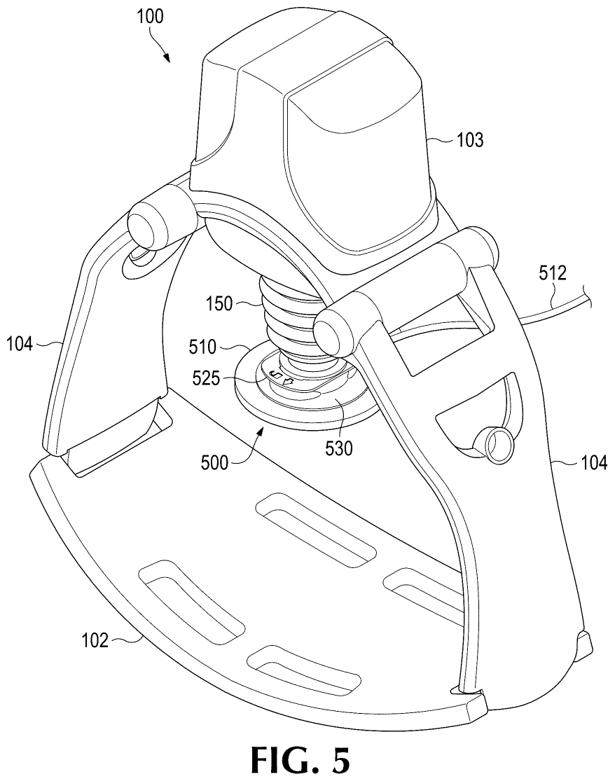

FIGS. 5-8 illustrate details of a puck assembly 500 according to configurations of the disclosure. FIG. 5 shows such a feedback puck 510 implemented with a CPR device 100, such as the device referred to with regard to FIG. 1. As shown, puck 510 may be secured to an end of a piston 150 with a locking plate 525 and may have an electrical cable 512 for electrically connecting puck 510 to the CPR device 100. Additionally or alternatively, electrical cable 512 may electrically connect puck 510 to a user interface of the CPR device with puck 510 is implemented, or electrical cable 512 may electrically connect puck 510 with a communication module for cooperation with other medical devices, such as a defibrillator. Puck 510 may also be substantially contained within a case 530.

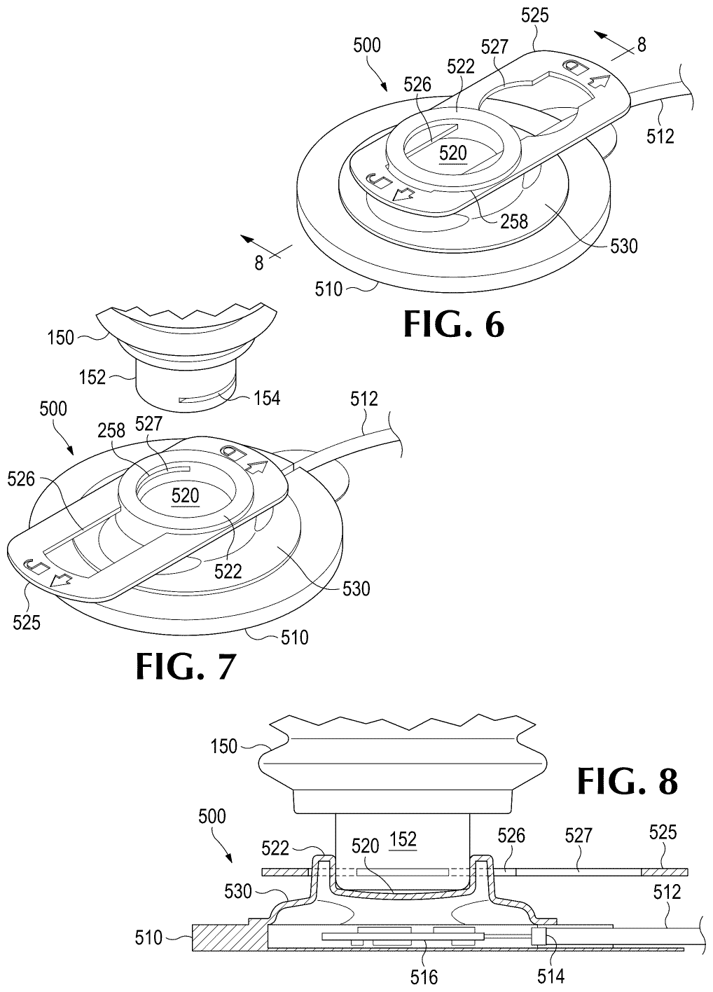

FIG. 6 shows further details of puck assembly 500, and, in particular, the locking plate 525. As shown in FIG. 6, puck assembly 500 has a puck 510 with a cylindrical extension 522 extending from a top surface of puck 510. Cylindrical extension 522 may substantially hollow, For the purposes of this disclosure, “substantially hollow” means largely or essentially empty, without requiring perfect vacancy. In this way, cylindrical extension 522 forms a recess 520 for receiving the piston of the CPR device. Locking plate 525, as shown in FIG. 6, is slidably coupled with cylindrical extension 522 of puck assembly 500. More specifically, locking plate 525 fits within slots 528 cut into cylindrical extension 522, and locking plate 525 is structured to slide back and forth along an axis transverse the piston. As shown, locking plate 525 has openings 526, 527, which correspond to locked and unlocked positions, respectively. Discussed in further detail below, openings 526, 527 are shaped such that the unlocked position allows piston to slide in or out of recess 520, while the locked position may either prevent a received piston from being removed from the recess 520 or prevent an unreceived piston from fitting through the corresponding opening.

FIG. 7 shows puck assembly 500 in the unlocked position. Opening 527 of locking plate 525, which corresponds to the unlocked position, is shaped to follow the curvature of cylindrical extension 522. Put differently, when locking plate 525 is in the unlocked position, locking plate 525 does not block any portion of recess 520, and recess 520 may receive the terminal end 152 of piston 150. Accordingly, piston 150 may be freely moved in and out of recess 520. Additionally, locking plate 525 may itself be removable from puck 510 when it is in the unlocked position.

Referring once again to FIG. 7, piston 150 also has slots 154. When piston 150 is received in recess 520 in the unlocked position, then, locking plate 525 may be slid laterally to the locked position. As shown in FIGS. 6-7, opening 526, which corresponds to the locked position, is shaped such that the portions of the locking plate 525 that fit within slots 528 of cylindrical extension 522 extend into recess 520. When piston 150 is received in recess 520 and locking plate 525 is slid laterally toward the locked position, the portions of the locking plate 525 extending into recess 520 thus fit into slots 154 of piston 150. In this way, opening 526 is shaped to limit the movement of piston 150 when locking plate 525 is slid laterally toward its locked position. In the locked position, which is shown in FIG. 8, puck assembly 500 is thus prevented from detaching from the piston 150 when compressions are performed.

For instance, in configurations such as those just described with regard to FIGS. 6-8, a rescuer may begin treatment of a patient with manual compressions. The rescuer may use the puck 510 alone to measure the quality of the manual compressions, for instance, by adhering the puck 510 to the patient's chest at a location where manual compressions are to be performed. The rescuer may perform the manual compressions and, in turn, may receive feedback from the puck 510 as a CPR device is prepared for use on the patient, perhaps by another rescuer. The rescuer performing manual compressions may decide to stop performing the manual compressions and instead begin compression performed by the CPR device. Accordingly, the rescuer implementing a CPR device and puck assembly 500, in configurations, may remove the puck 510 from the patient's chest and insert the puck 510 into opening 527 of the locking plate 525. The rescuer may then insert terminal end 152 of piston 150 into the recess 520 and slide the locking plate 525 toward the locked position, where the shape of opening 526 will cause portions of locking plate 525 to fit within slots 154 of piston 150. Once the puck assembly 500 is placed in the locking position, as described, the rescuer may then initiate the compressions performed by the CPR device.

When puck assembly 500 is implemented with a CPR device, as in FIG. 8, puck assembly 500 may travel with piston 150 due to the attachment of the puck assembly 500 to the terminal end 152 described above. In this way, the surface of puck 510 facing the chest of the patient contacts the chest as compressions are performed. The puck 510 may therefore stand in place of the terminal end 152 of piston 150 for applying the compression force. However, because puck 510 is attached and travels with the piston 150, puck 510 is not an obstacle on the patient's chest for the piston 150 to overcome, as has been discussed with regard to prior art feedback pucks. Rather, the attachment of puck 510 to piston 150 prevents drift of the piston 150 away from a desired compression location on the chest of the patient, as the patient's chest remains clear for receiving compressions.

FIG. 8 also shows a cross sectional view of puck assembly 500, according to the cross section identified in FIG. 6. As shown, puck 510 has a connector 514 at which electrical cable 512 may electrically connect the internal circuitry of puck 510, which may comprise sensors 516, to the CPR device or other external medical device. Connector 514, in configurations, may be an electrical port, allowing electrical cable 512 to be inserted into and removed from connector 514. Connector 514 may be a permanently wired connection, in configurations. Finally, although a wired connection is illustrated in FIG. 8, the connection between the internal sensors 516 and the CPR device or other external medical device may be wireless.

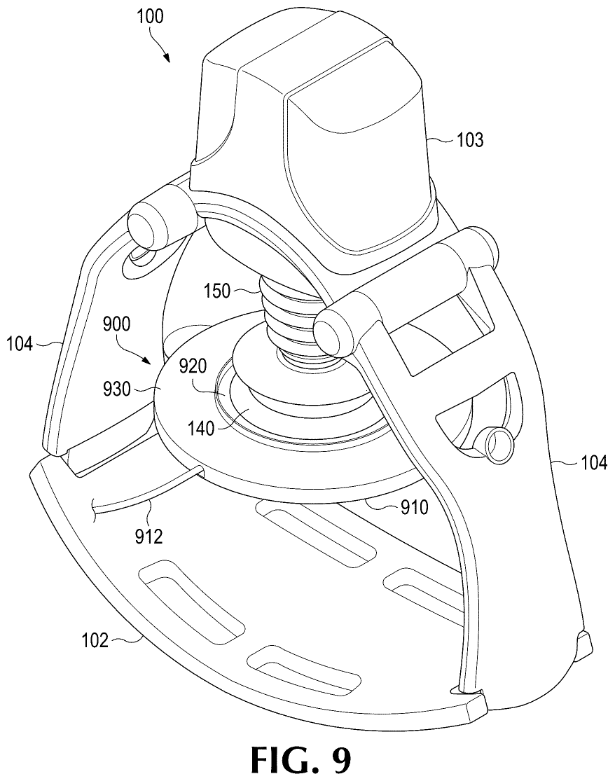

FIGS. 9-11 show details of an example puck assembly 900 for implementation with a CPR device, such as the one illustrated in FIGS. 1-2, according to configurations. As shown in FIG. 9, the puck assembly 900 has a feedback puck 910 and an electrical cable 912 for electrically connecting the feedback puck 910 to the CPR device. Additionally or alternatively, electrical cable 912 may electrically connect feedback puck 910 to a user interface of the CPR device with which puck assembly 900 is implemented, or electrical cable 912 may electrically connect feedback puck with a communication module for cooperation with other medical devices, such as a defibrillator. In still other configurations, electrical cable 912 electrically connects feedback puck 910 to an external device, such as a manual defibrillator or AED, for implementation with the external device before a mechanical CPR device is applied.

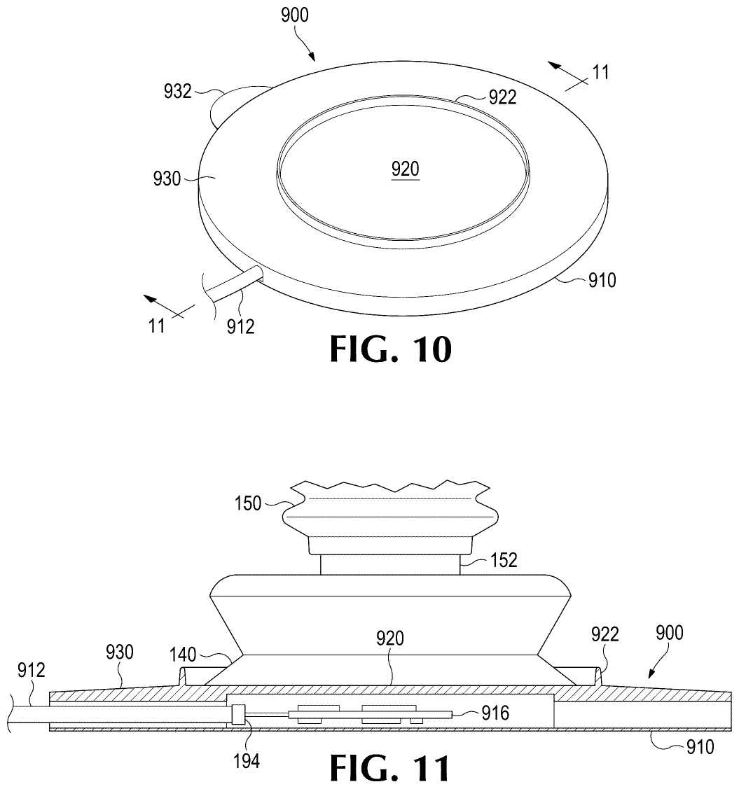

As shown in FIG. 10, feedback puck 910 is substantially contained within a case 930, which may be structured to attach to a suction cup 140 of the CPR device. In this way, puck assembly 900 may be a removable accessory to the CPR device, structured to geometrically fit over components of the CPR device. In particular, puck assembly 900 has a lip 922 extending from a top surface of puck 910. Lip 922 may be a circular extension, in configurations, such that lip 922 creates an attachment surface 920. Attachment surface 920 may be substantially flat and substantially contained within the boundaries of lip 922. For the purposes of this disclosure, “substantially flat” means largely or essentially flat, without requiring perfect flatness. Lip 922 and attachment surface 920 may accordingly be sized such that a suction cup 140 of the CPR device may interface with the attachment surface 920 and be substantially surrounded by lip 922. For the purposes of this disclosure, “substantially surrounded” means largely or essentially enclosed on all sides, without requiring perfect enclosure. In this way, lip 922 serves to guide suction cup 140 to a central position on the puck 910.

Because the attachment surface 920 of puck assembly 900 is substantially flat, suction cup 140 may be secured to the attachment surface 920 using the partial vacuum created by suction cup 140. Consequently, puck assembly 900 may be secured to the piston 150 by simply guiding the suction cup onto the attachment surface 920 within lip 922 and pressing the puck assembly 900 to create the partial vacuum with the suction cup 140. Once attached in this way, puck assembly 900 may travel with the piston 150 as compressions are applied.

For instance, in configurations such as those just described with regard to FIGS. 9-10, a rescuer may begin treatment of a patient with manual compressions. The rescuer may use the puck 910 alone to measure the quality of the manual compressions, for instance, by adhering the puck 910 to the patient's chest at a location where manual compressions are to be performed. The rescuer may perform the manual compressions and, in turn, may receive feedback from the puck 910 as a CPR device is prepared for use on the patient, perhaps by another rescuer. The rescuer performing manual compressions may decide to stop performing the manual compressions and instead begin compressions performed by the CPR device. Accordingly, the rescuer implementing a CPR device and puck assembly 900, in configurations, may remove the puck 910 from the patient's chest and place the puck assembly 900 over the suction cup 140 of the CPR device such that the suction cup 140 is secured to the attachment surface 920 within the boundaries of lip 922. Once the puck assembly 900 is placed in this position, as described, the rescuer may then initiate the compressions performed by the CPR device.

As mentioned, the puck assembly 900 may travel with the piston 150 of the CPR device when attached as described. In this way, the surface of the puck 910 facing the chest of the patient contacts the chest as compressions are performed. The puck 910 may therefore stand in place of the terminal end 152 of piston 150 for applying the compression force to the chest of the patient. However, because puck 910 is attached and travels with the piston 150, puck 910 is not an obstacle on the patient's chest for the piston 150 to overcome, as has been discussed with regard to prior art feedback pucks. Rather, the attachment of puck 910 to piston 150 prevents drift of the piston 150 away from a desired compression location on the chest of the patient, as the patient's chest remains clear for receiving compressions.

With reference to FIG. 10, puck assembly 900 also has a tab 932 to facilitate removal of the puck assembly from the suction cup 140. The tab 932, in configurations, may comprise a curved extension, extending laterally from the case 930 of the puck assembly 900. Although a curved extension is illustrated and described with regard to FIG. 10, in configurations, tab 932 may be differently shaped. When puck assembly is secured to the suction cup 140, tab 932 may be pulled downward, which may be understood as a direction toward the chest of the patient when CPR device is implemented. Pulling the tab 932 downward in this way breaks the partial vacuum created by suction cup 140 and thus breaks the attachment of puck assembly 900 to suction cup 140, allowing puck assembly 900 to be removed.

FIG. 11 shows a cross sectional view of puck assembly 900, according to the cross section identified in FIG. 10. As shown, puck 910 has a connector 914 at which electrical cable 912 may electrically connect the internal circuitry of puck 910, which may comprise sensors 916, to the CPR device or other external medical device. Connector 914, in configurations, may be an electrical port, allowing electrical cable 912 to be inserted into and removed from connector 914. Connector 914 may be a permanently wired connection, in configurations. Finally, although a wired connection is illustrated in FIG. 11, the connection between the internal sensors 916 and the CPR device or other external medical device may be wireless.

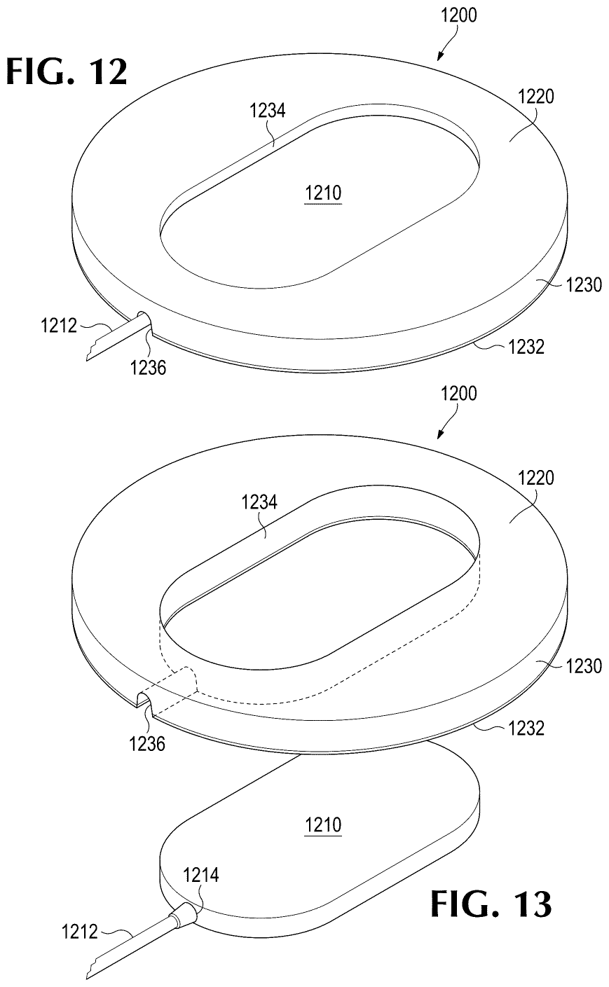

FIGS. 12-13 show details of an example puck assembly 1200 for implementation with a CPR device, such as the one illustrated in FIGS. 1-2, according to additional or alternative configurations of the disclosure. FIG. 12 shows puck assembly 1200 fully assembled, with a feedback puck 1210 received in body 1230 of puck assembly 1200. Just as described above with regard to alternative configurations, feedback puck 1210 has an electrical cable 1212 for electrically connecting feedback puck 1210 to the CPR device. Electrical cable 1212 may also electrically connect feedback puck 1210 to a user interface of the CPR device with which puck assembly 1200 is implemented, or electrical cable 1212 may electrically connect feedback puck 1210 with a communication module for cooperation with another medical device, such as a defibrillator.

As shown in FIG. 12, when puck assembly 1200 is fully assembled, feedback puck 1210 is substantially contained within a body 1230 of the assembly. Body 1230, in configurations, is structured to attach to a suction cup of the CPR device, and as shown, body 1230 has a substantially circular footprint. For the purposes of this disclosure, “substantially circular” means largely or essentially shaped as a circle, without requiring perfect circularity.

Referring now to FIG. 13, body 1230 also has a cutout 1234 for receiving feedback puck 1210. In configurations, body 1230 is a solid piece of a single material, and cutout 1234 comprises a portion of the material removed from body 1230 in a shape structured to accommodate the geometry of feedback puck 1210. In configurations, body 1230 is formed of a disposable foam, such as polystyrene, polyethylene, and polyurethane. Nonetheless, other suitable materials are used to form body 1230, configurations, and not all configurations of body 1230 are disposable.

As shown in FIG. 13, puck assembly 1200 also has a notch 1236 shaped to receive electrical cable 1212 and electrical connector 1214 of feedback puck 1210. In this way, when feedback puck 1210 is received in cutout 1234, electrical cable 1212 and electrical connector 1214 do not interfere with the surfaces of body 1230 that interface with either the patient's chest or the suction cup. Preferably, notch 1236 is structured to receive electrical cable 1212 and electrical connector 1214 with a snug fit. More particularly, in configurations, notch 1236 is structured to receive electrical cable 1212 and electrical connector 1214 while minimizing flow of air through notch 1236 that may potentially disrupt the seal of the suction cup, as described in further detail below.

To attach to a suction cup, body 1230 has a receiving surface 1220. Receiving surface 1220, in configurations, is substantially flat and is made of at least a portion of a surface of body 1230 facing the suction cup when puck assembly 1200 is implemented with a CPR device. As shown in FIG. 12, receiving surface 1220 is not, and need not be, perfectly flat or continuous in configurations. That is, receiving surface 1220 makes up a portion of the circular footprint of body 1230 nearest the outer edge, but receiving surface 1220 is discontinuous due to cutout 1234, in configurations. However, body 1230 is sized such that receiving surface 1220 provides a surface on which the outer lip of a suction cup can form a seal. Put differently, the circumference of the suction cup sealing lip fits within the outer circumference of body 1230, and the circumference of the suction cup sealing lip contacts the substantially flat portion of receiving surface 1220.

To attach a suction cup to receiving surface 1220, accordingly, the sealing lip of the suction cup is positioned to contact receiving surface 1220, and the suction cup is pressed to remove air from the inner chamber of the suction cup. Evacuating air from the suction cup in this way creates a negative pressure seal, maintaining attachment between the suction cup and receiving surface 1220.

When feedback puck 1210 is received in puck assembly 1200 and a suction cup is attached to receiving surface 1220, the presence of feedback puck 1210 prevents air from entering the suction cup. Accordingly, the suction cup can be pressed against the receiving surface 1220 to evacuate air and form a negative pressure seal, and air will not subsequently enter the suction cup and break the seal with receiving surface 1220. In still other configurations, puck assembly 1200 includes an insert that can be removed from or installed into puck assembly 1200 to prevent air from entering the suction cup if feedback puck 1210 is not present.

In some configurations, receiving surface 1220 is formed of a separate material from the material forming body 1230. For instance, in some configurations, receiving surface 1220 is formed of a substantially pliant plastic material coating body 1230. For the purposes of this disclosure, “substantially pliant” means largely or essentially flexible or bendable, without requiring complete flexibility or bendability. In such configurations, the substantially pliant plastic material forming receiving surface 1220 provides a smooth surface for the suction cup to attach to, and the material prevents airflow into the suction cup. Additionally, because the plastic material implemented in some configurations is substantially pliant, the plastic material is not broken by pressure applied during performance of mechanical CPR compressions.

In configurations, puck assembly 1200 also has an adhesive surface 1232 on a portion of body 1230 opposite the receiving surface—i.e., a portion of body 1230 facing the chest of a patient receiving compressions from a CPR device. Thus, when puck assembly 1200 is implemented with a CPR device, puck assembly 1200 can first be adhered to a patient's chest. In configurations, adhesive surface 1232 comprises an adhesive material disposed on the surface of body 1230 that interfaces with the patient's chest. In some configurations, a removable cover is included over adhesive surface 1232, and a rescuer implementing puck assembly 1200 removes the removable cover to exposed adhesive surface 1232 before attaching puck assembly 1200 to the chest of a patient.

A suction cup implemented with the CPR device can then be attached to receiving surface 1220 as described above, forming a negative pressure seal with receiving surface 1220. With puck assembly 1210 attached to both the chest of the patient and the suction cup of a CPR device, such as the example device shown in FIGS. 1-2, mechanical CPR compressions can be performed to the chest of the patient without puck assembly 1210 interfering with the compressions. That is, because puck assembly 1210 provides the receiving surface 1220 to maintain an adequate seal with a suction cup of the CPR device, and because receiving surface 1220 is sized to be wider than the suction cup, the suction cup remains attached to puck assembly 1210 during performance of mechanical CPR compressions and does not move from its optimal position.

Additionally, because configurations of puck assembly 1210 include adhesive surface 1234 to attach puck assembly 1210 to the patient's chest, chest lifts can be performed with the CPR device without the suction cup detaching from the patient's chest. Put differently, when the CPR device is configured to perform chest lifts, the CPR device pulls the puck assembly 1210 via the vacuum seal of the suction cup on receiving surface 1220, and adhesive surface 1234 pulls on the patient's chest to lift the patient's chest along with the suction cup.

In configurations, such as any of those described with regard to FIGS. 1-13, a puck assembly compatible with a CPR device may be formed of material selected such that the puck assembly is substantially incompressible. For the purposes of this disclosure, “substantially incompressible” means largely or essentially resistant to being reduced in size or volume by pressure, without requiring perfect resistance. Put differently, configurations of disclosed technology may provide a puck assembly that transfers compression force and/or lifting force from a CPR device to the chest of the patient, minimizing energy losses to compression of the puck assembly itself. In configurations, the CPR device is configured to detect or otherwise account for the presence of a puck assembly and, accordingly, compensate for compression of the puck assembly in its calculations of applied compression depth. For example, in configurations implementing a puck assembly with a CPR device, the CPR device can recognize the presence of the puck assembly and slightly increase compression depth relative to a standard profile for situations without a puck assembly.

Additionally, in configurations, at least an upper surface of the feedback puck may be formed of material selected such that the upper surface is substantially slip resistant. For the purposes of this disclosure, “substantially slip resistant” means largely or essentially resistant to sliding motion, without requiring perfect resistance. In this way, a rescuer utilizing the feedback puck alone for manual compressions may maintain sufficient grip on the feedback puck as manual compressions are performed.

With reference to any of the above, configurations of the disclosed technology provide a CPR feedback puck for measuring quality of compressions that is compatible with a mechanical CPR device and thus may be implemented with a CPR device without reducing the quality of treatment. In particular, in configurations such as those described above, the compatible feedback puck may electrically connect with the CPR device, which may be configured to make its own measurements of CPR parameters like displacement of the piston. When configurations of the feedback puck are implemented with a CPR device, then, measurements from the feedback puck and the CPR device may be combined to further enhance and improve treatment quality.

For example, when a feedback puck and CPR device are implemented together, according to configurations, measurements from the feedback puck and measurements from the CPR device in combination may detect inappropriate use of the feedback puck. In situations where a feedback puck is first used for manual compressions and is not attached to the CPR device, a rescuer may decide to transition to compressions from the CPR device but may fail to properly attach the feedback puck. The rescuer may fail to remove the feedback puck from the patient's chest and initiate compressions with the CPR device over the feedback puck. In configurations implementing a compatible puck, such as configurations described above, measurements from the puck and CPR device may detect such failures.

To detect inappropriate simultaneous use of the CPR device and feedback puck, configurations of the disclosure may have an air-pressure sensor within the suction cup of the CPR device. The air-pressure sensor may measure an air pressure within the suction cup and accordingly determine whether the air pressure within the suction cup exceeds a predetermined threshold. That is, the air-pressure sensor may determine that air pressure within the suction cup is approaching, or has reached, atmospheric pressure acting on the outside of the suction cup, and therefore the suction cup is not attached. Based on a determination that air pressure within the suction cup is at or near atmospheric pressure, the CPR device may determine that a foreign object, such as the feedback puck, has interfered with proper attachment. Therefore, in configurations implementing an air-pressure sensor, the CPR device may detect whether the pressure inside the suction cup has exceeded some threshold below atmospheric pressure. Additionally or alternatively, in configurations, the CPR device may have a force sensor configured to detect a lifting force exerted by the piston on the patient's chest. The CPR device may further determine whether the detected lifting force exceeds a predetermined lifting-force threshold. When the lifting force does not exceed this predetermined threshold, the CPR device may determine that a foreign object, such as the feedback puck, is present on the patient's chest. Furthermore, in additional or alternative configurations, the CPR device may have a proximity sensor configured to detect a distance between the patient's chest and an end of the piston. The CPR device may further determine whether this detected distance exceeds a predetermined threshold and may thus determine that, when the predetermined threshold is exceeded, a foreign object, such as the feedback puck, is present on the patient's chest. For example, the CPR device may determine that the predetermined threshold distance is exceeded because the suction cup has detached, and therefore the distance between an end of the piston and the patient's chest is greater than the threshold. In additional or alternative configurations, a proximity sensor is configured to measure changes in the proximity between an end of the piston and the patient's chest throughout compression and decompression cycles. In this way, the proximity sensor is configured to determine that, if the change in proximity exceeds a predetermined threshold over the course of a cycle, the suction cup has detached.

The CPR device may be further configured to provide a human-perceptible warning that a foreign object has been detected, as described above, and that the feedback puck should either be removed or be properly attached to the CPR device for continued treatment. The human-perceptible warning may comprise a visual warning, such as a pop-up indicator triggered to extend from the CPR device when a foreign object is detected. Additionally or alternatively, the human-perceptible warning may comprise an audible warning, such as a particular noise associated with detecting a foreign object or a verbal warning that a foreign object is present.

With reference to any of the above, configurations of the CPR feedback puck may also be used to identify lateral movement of the CPR device during compressions. Put differently, a CPR feedback puck implemented with a CPR device, according to configurations of the disclosure, may detect whether the piston of the CPR device has drifted from an optimal compression point on the patient's chest. Sensors of the feedback puck may include, for example, an accelerometer configured to detect such lateral movement of the feedback puck. In implementation, detected lateral movement of the feedback puck would accordingly indicate lateral movement of the piston of the CPR device, as the feedback puck travels with the piston of the CPR device.

Configurations of the disclosed technology may also provide a CPR feedback puck separate from the CPR device but configured to electrically connect with the CPR device. Specifically, in configurations, a CPR feedback puck may be provided with an adhesive sheet to adhere the CPR feedback puck to a patient's chest for manual compressions to be performed. The CPR feedback puck may be structured, for example, to be a substantially flat disc that is larger in diameter than a suction cup secured to the piston of the CPR device. Because the CPR feedback puck has a larger diameter than the suction cup and is structured to be substantially flat, the suction cup may secured to a surface of the CPR feedback puck, without any breaking of the partial vacuum keeping the suction cup secured. In this way, when a CPR device is positioned over a patient's chest having a CPR feedback puck adhered, the suction cup may properly attach to the CPR feedback puck. Although, in configurations, the CPR feedback puck may be adhered to the chest of the patient and not otherwise physically couplable with a CPR device, the CPR feedback puck may be structured such that a CPR device may be secured to the patient's chest through the CPR feedback puck.

The adhesive sheet, in configurations, may substantially cover the CPR feedback puck. As used in this disclosure, “substantially cover” means largely or essentially extends over the entirety of a component. Accordingly, the adhesive sheet may be disposed over the upper surface of the puck interfacing with the suction cup and may extend laterally beyond the diameter of the puck. The portion of the adhesive sheet extending laterally beyond the diameter of the puck may then be adhered to the patient's chest, substantially encapsulating the puck between the adhesive sheet and the patient's chest. As used in this disclosure, “substantially encapsulating” means largely or essentially enclosing.

Additionally, in configurations implementing a CPR feedback puck over which a CPR device may be secured, the CPR feedback puck may be formed of a material such that the puck is substantially incompressible. Put differently, configurations of disclosed technology may provide a puck assembly that transfers compression force and/or lifting force from a CPR device to the chest of the patient without losing energy to compression of the puck assembly itself.

As previously discussed, prior art CPR feedback pucks do not have such compatibility with mechanical CPR devices and cannot detect and/or warn of inappropriate use of the two devices in tandem. Consequently, prior art systems require rescuers to apply their own expertise and observations during rescue events to determine whether treatment is of optimal quality as a CPR device performs compressions or active decompressions over a feedback puck. Configurations of the disclosed technology, conversely, provide information regarding the quality of the treatment and instruct the rescuer whether a different course of action must be taken to optimize treatment with both the feedback puck and CPR device.

Additionally, a feedback puck that is compatible with a CPR device, according to configurations, may be electrically connected with and thus in communication with other external devices. For example, in configurations, a feedback puck implemented with a CPR device may be connected to a defibrillator, tablet, user interface of the CPR device, or other device. Configurations of the disclosed technology may accordingly combine measurements of the feedback puck not only with measurements made by the CPR device but also with data and/or measurements from other devices. In this way, implementation of the compatible feedback puck may allow for communication and display of feedback to a rescuer from multiple sources.

When implemented with a defibrillator, for example, the combination of the CPR device and feedback puck may detect whether manual compressions or mechanical CPR device compression are being performed. Specifically, a defibrillator may capture a distinctive artifact on the patient's impedance trace when compressions are delivered by a mechanical CPR device. Consequently, when using a defibrillator in conjunction with a feedback puck and mechanical CPR device, the defibrillator may capture both the distinctive artifact of the CPR device and data acquisition from the feedback puck. When both are detected, the CPR device may thus determine that simultaneous use of the CPR device and feedback puck is occurring, and the device may provide a human-perceptible warning of such simultaneous use, such as the visual and audible warnings described above.

With the above listed electrical connections and capabilities, configurations of the disclosed technology may perform a variety of functions, including but not limited to combinations of the following functions: measuring motion and/or force of compressions, measuring rate of compressions, measuring releases between compressions, measuring vertical position of the puck when no upward force is applied, communicating with a host device, recording a file of measurements for later review or transmission to a CPR device, displaying feedback information to a rescuer, and communicating feedback from a CPR device based on its own measurements of a patient's chest movement.

### EXAMPLES

Illustrative examples of the disclosed technologies are provided below. A particular configuration of the technologies may include one or more, and any combination of, the examples described below.

Example 1 includes a method of warning an operator of a mechanical cardiopulmonary resuscitation (CPR) device about a foreign object, the method comprising the mechanical CPR device, comprising: detecting a foreign object between a piston of the mechanical CPR device and a patient's chest; and notifying an operator of the mechanical CPR device that a foreign object was detected.

Example 2 includes the method of Example 1, in which the detecting the foreign object comprises evaluating whether a signal from an air-pressure sensor within a suction cup coupled to the piston and configured to measure an air pressure within the suction cup to determine whether the air pressure exceeds a predetermined air-pressure threshold.

Example 3 includes the method of any of Examples 1-2, in which the detecting the foreign object comprises evaluating whether a signal from a proximity sensor configured to detect a distance between the patient's chest and an end of the piston to determine whether the distance exceeds a predetermined distance threshold.

Example 4 includes the method of any of Examples 1-3, in which the detecting the foreign object comprises evaluating whether a signal from a force sensor configured to detect a lifting force applied by the piston to the patient's chest to determine whether the lifting force exceeds a predetermined lifting-force threshold.

Example 5 includes the method of any of Examples 1-4, further comprising detecting whether the mechanical CPR device is applying CPR compressions to the patient's chest.

Example 6 includes the method of Example 5, in which the detecting whether the mechanical CPR device is applying CPR compressions to the patient's chest comprises: receiving an impedance trace from a defibrillator; and evaluating a shape of the impedance trace to determine whether mechanical CPR or manual CPR is being applied to the patient's chest.

Example 7 includes the method of Example 5, in which the detecting whether the mechanical CPR device is applying CPR compressions to the patient's chest comprises: receiving an accelerometer signal from a sensor on the patient's chest; and evaluating the accelerometer signal to determine whether mechanical CPR is being applied to the patient's chest.

Example 8 includes the method of any of Examples 1-7, in which the notifying the operator comprises providing a visual warning to the operator.

Example 9 includes the method of Example 8, in which the providing the visual warning comprises triggering a pop-up indicator to extend from the CPR device.

Example 10 includes the method of any of Examples 1-9, in which the notifying the operator comprises providing an audible warning to the operator.

Example 11 includes the method of any of Examples 1-10, in which the notifying the operator comprises providing instructions to the operator to remove the foreign object from between the piston of the mechanical CPR device and the patient's chest.

Example 12 includes a mechanical cardiopulmonary resuscitation (CPR) device comprising: a piston configured to extend toward and away from a patient's chest during CPR chest compressions; and a compression interface attached to an end of the piston, the compression interface including a sleeve configured to secure a CPR puck within the sleeve during CPR chest compressions.

Example 13 includes the mechanical CPR device of example 12, in which the compression interface comprises a suction cup.

Example 14 includes the mechanical CPR device of any of examples 12-13, in which the compression interface comprises a compression pad.

Example 15 includes a mechanical cardiopulmonary resuscitation (CPR) device comprising: a piston configured to extend toward and away from a patient's chest during CPR chest compressions; and a compression interface, including: a recess structured to receive an end of the piston, a gasket structured to secure the piston in the recess, and a sleeve configured to secure a CPR puck within the sleeve during CPR chest compressions.

Example 16 includes the mechanical CPR device of Example 15, in which the compression interface comprises a suction cup.

Example 17 includes the mechanical CPR device of any of Examples 15-16, in which the compression interface comprises a compression pad.

Example 18 includes the mechanical CPR device of any of Examples 15-17, in which the compression interface is removable from the piston.

Example 19 includes the mechanical CPR device of Examples 18, in which removing the compression interface comprises applying a force to the compression interface in a direction away from the piston.

Example 20 includes a mechanical cardiopulmonary resuscitation (CPR) device comprising: a piston configured to extend toward and away from a patient's chest during CPR chest compressions, the piston having a magnet disposed on a terminal end; and a compression interface, including: a magnetic material disposed on a surface of the compression interface and configured to attach to the magnet of the piston, and a sleeve configured to secure a CPR puck within the sleeve during CPR chest compressions.

Example 21 includes the mechanical CPR device of Example 20, in which the compression interface comprises a suction cup.

Example 22 includes the mechanical CPR device of any of Examples 20-21, in which the compression interface comprises a compression pad.

Example 23 includes the mechanical CPR device of any of Examples 20-22, in which the compression interface is removable from the piston.

Example 24 includes the mechanical CPR device of Example 23, in which removing the compression interface comprises applying a force to the compression interface in a direction away from the piston.

Example 25 includes the mechanical CPR device of any of Examples 20-24, in which the magnet is a permanent magnet.

Example 26 includes the mechanical CPR device of any of Examples 20-24, in which the magnet is an electromagnet.

Example 27 includes a mechanical cardiopulmonary resuscitation (CPR) device comprising: a piston configured to extend toward and away from a patient's chest during CPR chest compressions; a CPR puck having a cylindrical extension extending from a top surface, the cylindrical extension structured to receive an end of the piston; and a locking plate structured to slide laterally along an axis transverse the end of the piston to lock the piston in the cylindrical extension of the CPR puck.

Example 28 includes the mechanical CPR device of Example 27, in which the locking plate has a first opening corresponding to an unlocked position and a second opening corresponding to a locked position.

Example 29 includes the mechanical CPR device of Example 28, in which the cylindrical extension of the CPR puck has at least one slot cut into a portion of the cylindrical extension, and in which the piston has at least one slot cut into a portion of the end of the piston.

Example 30 includes the mechanical CPR device of Example 29, in which the slot cut into the cylindrical extension and the slot cut into the end of the piston align when the piston is received in the cylindrical extension.

Example 31 includes the mechanical CPR device of Example 30, in which the second opening of the locking plate is shaped such that a portion of the locking plate fills the slot of the cylindrical extension and the slot of the piston and locks the piston in its received position.

Example 32 includes the mechanical CPR device of Example 30, in which the first opening of the locking plate is shaped such that the slot of the cylindrical extension and the slot of the piston are not filled and the piston is freely removable from its received position.

Example 33 includes the mechanical CPR device of any of examples 27-32 in which the CPR puck is a compression interface configured to deliver compression to a chest of a patient when the CPR puck is locked to the piston.

Example 34 includes a mechanical cardiopulmonary resuscitation (CPR) device comprising: a piston configured to extend toward and away from a patient's chest; a suction cup secured to an end of the piston; and a CPR puck having substantially flat surface structured to be secured to the suction cup.

Example 35 includes the mechanical CPR device of Example 34, in which the CPR puck has a lip extending from the substantially flat surface, the lip structured to guide the suction cup to the substantially flat surface to be secured.

Example 36 includes the mechanical CPR device of any of Examples 34-35, in which the CPR puck includes a tab extending laterally from a side of the CPR puck.

Example 37 includes the mechanical CPR device of any of Examples 34-36, in which the CPR puck is removable from the suction cup by applying a force to the tab in a direction away from the suction cup.

Aspects may operate on a particularly created hardware, on firmware, digital signal processors, or on a specially programmed general purpose computer including a processor operating according to programmed instructions. The terms “controller” or “processor” as used herein are intended to include microprocessors, microcomputers, ASICs, and dedicated hardware controllers. One or more aspects may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, RAM, etc. As will be appreciated by one of skill in the art, the functionality of the program modules may be combined or distributed as desired in various configurations. In addition, the functionality may be embodied in whole or in part in firmware or hardware equivalents such as integrated circuits, field programmable gate arrays (FPGA), and the like. Particular data structures may be used to more effectively implement one or more aspects of the disclosed systems and methods, and such data structures are contemplated within the scope of computer executable instructions and computer-usable data described herein.

The previously described versions of the disclosed subject matter have many advantages that were either described or would be apparent to a person of ordinary skill. Even so, all of these advantages or features are not required in all versions of the disclosed apparatus, systems, or methods.

Additionally, this written description makes reference to particular features. It is to be understood that the disclosure in this specification includes all possible combinations of those particular features. For example, where a particular feature is disclosed in the context of a particular example configuration, that feature can also be used, to the extent possible, in the context of other example configurations.

Also, when reference is made in this application to a method having two or more defined steps or operations, the defined steps or operations can be carried out in any order or simultaneously, unless the context excludes those possibilities.

Furthermore, the term “comprises” and its grammatical equivalents are used in this application to mean that other components, features, steps, processes, operations, etc. are optionally present. For example, an article “comprising” or “which comprises” components A, B, and C can contain only components A, B, and C, or it can contain components A, B, and C along with one or more other components.

Also, directions such as “vertical,” “horizontal,” “right,” and “left” are used for convenience and in reference to the views provided in figures. But the CPR device may have a number of orientations in actual use. Thus, a feature that is vertical, horizontal, to the right, or to the left in the figures may not have that same orientation or direction in actual use.

Although specific example configurations have been described for purposes of illustration, it will be understood that various modifications may be made without departing from the spirit and scope of the disclosure.

We claim:

1. A method of warning an operator of a mechanical cardiopulmonary resuscitation (CPR) device about a foreign object, the method comprising the mechanical CPR device:
detecting a foreign object between a piston of the mechanical CPR device and a patient's chest; and
notifying an operator of the mechanical CPR device that a foreign object was detected.

2. The method of claim 1, in which the detecting the foreign object comprises evaluating whether a signal from an air-pressure sensor within a suction cup coupled to the piston and configured to measure an air pressure within the suction cup to determine whether the air pressure exceeds a predetermined air-pressure threshold.

3. The method of claim 1, in which the detecting the foreign object comprises evaluating whether a signal from a proximity sensor configured to detect a distance between the patient's chest and an end of the piston to determine whether the distance exceeds a predetermined distance threshold.

4. The method of claim 1, in which the detecting the foreign object comprises evaluating whether a signal from a force sensor configured to detect a lifting force applied by the piston to the patient's chest to determine whether the lifting force exceeds a predetermined lifting-force threshold.

5. The method of claim 1, further comprising detecting whether the mechanical CPR device is applying CPR compressions to the patient's chest.

6. The method of claim 5, in which the detecting whether the mechanical CPR device is applying CPR compressions to the patient's chest comprises:
receiving an impedance trace from a defibrillator; and
evaluating a shape of the impedance trace to determine whether mechanical CPR or manual CPR is being applied to the patient's chest.

7. The method of claim 5, in which the detecting whether the mechanical CPR device is applying CPR compressions to the patient's chest comprises:
receiving an accelerometer signal from a sensor on the patient's chest; and
evaluating the accelerometer signal to determine whether mechanical CPR is being applied to the patient's chest.

8. The method of claim 1, in which the notifying the operator comprises providing a visual warning to the operator.

9. The method of claim 8, in which the providing the visual warning comprises triggering a pop-up indicator to extend from the CPR device.

10. The method of claim 1, in which the notifying the operator comprises providing an audible warning to the operator.

11. The method of claim 1, in which the notifying the operator comprises providing instructions to the operator to remove the foreign object from between the piston of the mechanical CPR device and the patient's chest.

12. A mechanical cardiopulmonary resuscitation (CPR) device comprising:
a piston configured to extend toward and away from a patient's chest during CPR chest compressions; and
a compression interface attached to an end of the piston, the compression interface including a sleeve configured to secure a CPR puck within the sleeve during CPR chest compressions.

13. The mechanical CPR device of claim 12, in which the compression interface comprises a suction cup.

14. The mechanical CPR device of claim 12, in which the compression interface comprises a compression pad.

15. The mechanical CPR device of claim 12, in which the compression interface is removable from the piston.

16. A mechanical cardiopulmonary resuscitation (CPR) device comprising:
a piston configured to extend toward and away from a patient's chest during CPR chest compressions; and
a compression interface, including:
a recess structured to receive an end of the piston,
a gasket structured to secure the piston in the recess, and
a sleeve configured to secure a CPR puck within the sleeve during CPR chest compressions.

17. The mechanical CPR device of claim 16, in which the compression interface comprises a suction cup.

18. The mechanical CPR device of claim 16, in which the compression interface comprises a compression pad.

19. The mechanical CPR device of claim 16, in which the compression interface is removable from the piston.

20. The mechanical CPR device of claim 19, in which removing the compression interface comprises applying a force to the compression interface in a direction away from the piston.
